(19) United States
(12) Patent Application Publication
(10) Pub. No.: US 2007/0284165 A1
(43) Pub. Date: Dec. 13, 2007

(54) Vehicle Hydraulic Regenerative System

(76) Inventor: Rickie W. Patterson, Zebulon, NC (US)

Correspondence Address: THE PARKER LAW OFFICE, PLLC, 800 COUNTRY CLUB DRIVE, PO BOX 8334, ROCKY MOUNT, NC, 27804-1334, US

(21) Appl. No.: 11/423,700

(22) Filed: Jun. 12, 2006

(51) Int. Cl. B60L 8/00; B60K 17/00

(52) U.S. Cl. 180/65.3; 180/305

(57) ABSTRACT

A regenerative system for a recharging vehicle batteries utilizing a hydraulic circuit having a hydraulic pump linked to a non-drive axle powering the pump, the pump providing power to at least one hydraulic generator so that the generator operates continuously within optimum operating parameters once the vehicle travels at or above a predetermined speed.

### BACKGROUND OF THE INVENTION

1. Field of Invention

This invention relates to regenerative energy systems for vehicles. More particularly, this invention relates to a hydraulically driven, constant output, regenerative drive system by converting non-drive axle rotational energy into electric energy.

2. Description of the Related Art

Extensive efforts to increase utilization of electric vehicles have been made over the last few decades. While the environmental benefits of electric vehicle usage are generally accepted and sought after in modern society, the technology has not yet provided solutions enabling electric vehicles to rival those powered by internal combustion engines in travel range and performance other performance characteristics.

Prior systems and devices take various approaches to solving the problems of electric vehicle operational performance. Improvements in battery technology, motor technology, and regenerative technology, among others, continue to result in improvements in electric vehicle range and performance. Notably, the use of hybrid vehicles utilizing combinations of electric motor and internal combustion engine technologies has reached mass-market application. However, the need for improved electric vehicle systems still exists to improve vehicle operating range.

Regenerative systems convert otherwise lost kinetic energy into usable energy. Typically, regenerative systems are utilized to recharge batteries. A common use of regenerative systems is in the field of regenerative braking. These systems convert energy otherwise lost during mechanical braking by utilizing electric generators to assist in vehicle deceleration. These generators provide electrical energy to vehicle batteries, improving vehicle performance by extending a battery's original charge. However, such systems are typically limited to providing regenerative power during vehicle braking or deceleration.

One of the recognized problems in regenerative technologies is electric motor inefficiency over a wide range of vehicle operating parameters. Electric motors typically operate most efficiently within a predetermined range. Thus, electric motors are typically specified based on typical system operating ranges and system characteristics so that they operate most efficiently during use. While motor selection in many static applications can be readily achieved, this task is more difficult in vehicle regenerative systems since a vehicle typically operates within a wide range of speeds. The vehicle might operate at relatively low speeds during stop and go traffic in congested urban traffic. The same vehicle would operate at fast cruising speeds on open highways or expressways.

Prior systems attempted to overcome this limitation by providing a range of electric motors within the regenerative system. Thus, a predetermined motor could operate when the vehicle operates at a speed coinciding with the motors preferred operating range. However, such systems cannot provide continuous, efficient operation within a wide range of vehicle speeds.

Regenerative systems for vehicles typically provide direct mechanical linkages from a vehicle's tires or axles to electric generators. In some designs, the generators may also function as motors to provide primary or secondary motive power to the vehicle's tires. Since mechanical linkages are used, the rotational input powering the generator is directly proportional to vehicle speed. Direct mechanical linkages therefore impose inherent limitations on a regenerative systems ability to operate efficiently since the generator operates most efficiently only when the vehicle travels within a relatively narrow range of speeds.

Additionally, generator output varies based on the power input provided to the generator. Regenerative systems frequently employ regulator circuits to ensure that the electric energy supplied to a vehicle's batteries is uniform, preventing damage to the batteries. These circuits also usually act to ensure that charging operations occur only when the batteries can accept a charge. While such circuits are effective in providing uniform electrical energy to batteries, they do not improve operational performance of the generator itself.

Therefore, what is needed is a system that provides for optimum operation of regenerative system generators over a wide range of vehicle operating speeds. More efficient operation will result in improved vehicle operational characteristics such as increased travel distance. Additionally, more efficient systems should reduce overall vehicle weight, further increasing vehicle performance.

### BRIEF SUMMARY OF THE INVENTION

An object of the present invention is to enhance electric vehicle operating range by providing a regenerative system for a vehicle capable of converting rotational energy from a non-drive axle into electrical energy.

A second object of the present invention is to provide efficient regeneration of energy in a vehicle over a wide range of operating parameters by providing a hydraulically driven generator means for providing steady electrical output for recharging vehicle batteries.

A third object of the present invention is to enhance electric vehicle performance by utilizing the non-drive axle and tires of a vehicle as a flywheel and converting otherwise lost kinetic energy into electricity for recharging vehicle batteries.

To achieve the foregoing objects, and in accordance with the purpose of the invention as broadly described herein, the present invention provides a hydraulic regenerative system for an automobile powered by the rotation of a non-drive axle during vehicle operation.

In a first aspect, the invention comprises a rotating non-drive axle having a pump connecting thereto; at least one hydraulic generator in fluid communication with the pump wherein the pump powers the generator; the generator in electrical communication with at least one battery for recharging the battery during operation.

In a second aspect, the invention comprises a plurality of hydraulic generators driven within predetermined operating parameters by a pump connecting to a non-drive axle, the generators operating at a steady output.

In a third aspect, the invention comprises a regulator circuit for managing recharging of the battery and preventing battery overcharge.

In the preferred embodiment, an electric vehicle is provided having a non-drive axle having at least one rotating tire in connection with a road surface affixed thereon. A connecting means connects a hydraulic pump to the axle. A hydraulic circuit containing hydraulic fluid therein provides fluid communication between the hydraulic pump and plurality of hydraulic generators operating in parallel and forming a generator block. A pressure bypass system provides for steady pressure within the hydraulic circuit so that the hydraulic generators operate at uniform levels within their optimum operating efficiency ranges. The generator block provides electric energy to vehicle batteries for recharging the batteries. An energy management circuit regulates energy flow to the batteries to prevent overcharging or battery damage.

The present invention will now be described with reference to the following drawings, in which like reference numbers denote the same element throughout.

### BRIEF DESCRIPTION OF THE DRAWINGS

FIG. 1 is a schematic view of the present invention.

FIG. 2 is a schematic view of the present invention preferred embodiment having more than one hydraulic generator.

FIG. 3 is a schematic detail view of a generator block comprising a plurality of generators operating in parallel.

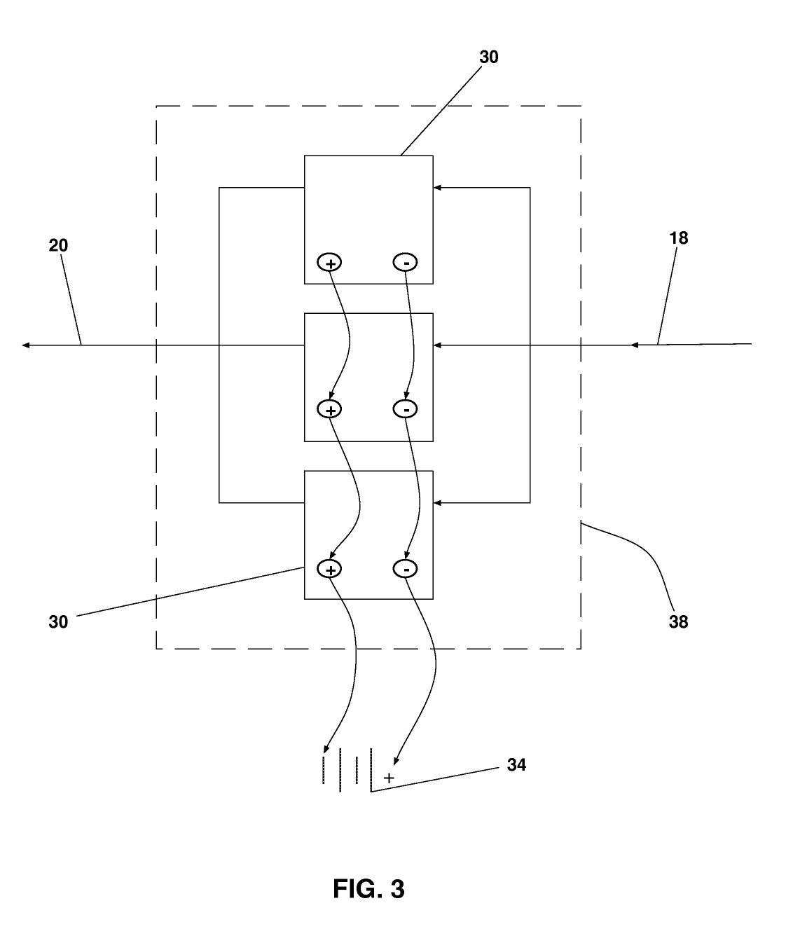

### DETAILED DESCRIPTION OF THE INVENTION

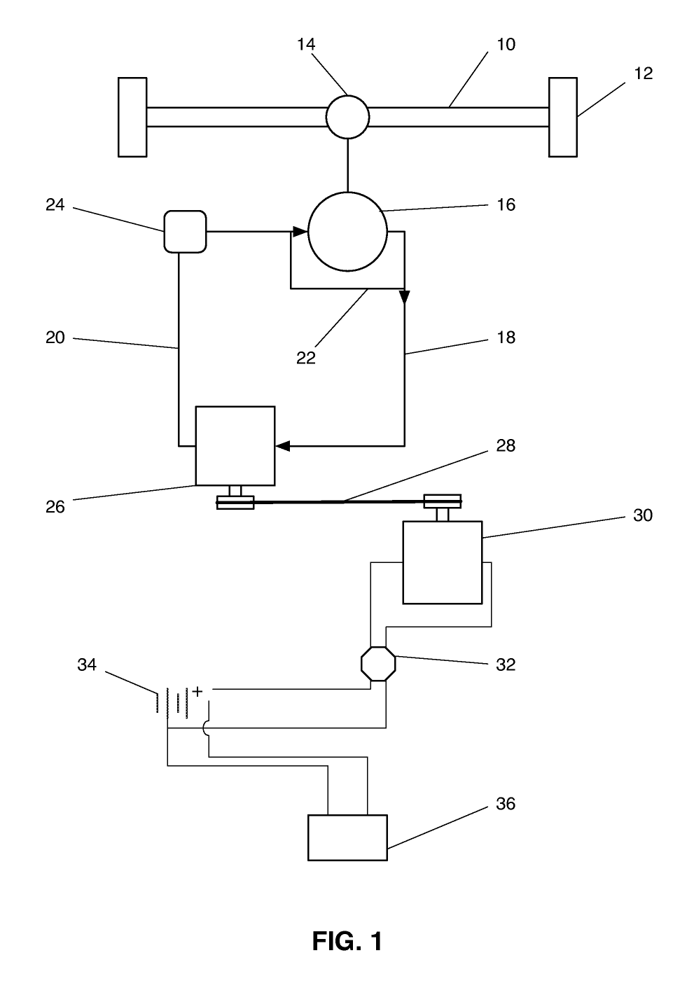

FIG. 1 depicts a vehicle axle 10 having two tires 12 and a geared differential 14 affixed thereto. The axle 10 is preferably a non-drive axle 10. A connecting means connects a hydraulic pump 16 to the differential 14 so that tire 12 and axle 10 rotation powers the hydraulic pump 16. A hydraulic circuit comprised of a supply line 18 and return line 20 provides fluid communication between the hydraulic pump 16 and a hydraulic motor 26. The circuit further comprises a hydraulic fluid reservoir 24 for retaining proper levels of hydraulic fluid during operation. A pressure bypass line 22 having a flow control valve provides fluid communication between the supply line 18 and return line 20 so that pressure levels are maintained between the supply and return line 20 during operation. Pressurized hydraulic fluid powers the hydraulic motor 26 as the hydraulic fluid moves through the hydraulic circuit under power form the hydraulic pump 16.

A connecting means, such as a tensioned pulley 28, couples the hydraulic motor 26 to a mechanical generator 30. Rotation of the hydraulic motor 26 powers rotation of the generator 30 so that the generator 30 provides electrical energy output. Since a bypass line 22 is provided in the hydraulic circuit, uniform rotational output of the hydraulic motor 26 is capable once the vehicle travels at or above a predetermined velocity. Uniform hydraulic motor 26 output enables the generator 30 to produce uniform electrical output of steady voltage. Further, the generator 30 may be sized to operate at peak operating efficiency over a wide range of vehicular motion.

The vehicle has a battery 34 or battery block in electrical communication with the generator 30. A control circuit 32 is preferably provided to monitor and manage vehicle charging to ensure overcharging does not occur. Control circuits 32 are widely known in the art. The battery is in electrical communication with an electric motor 36 that in turn provides motive power to the vehicle.

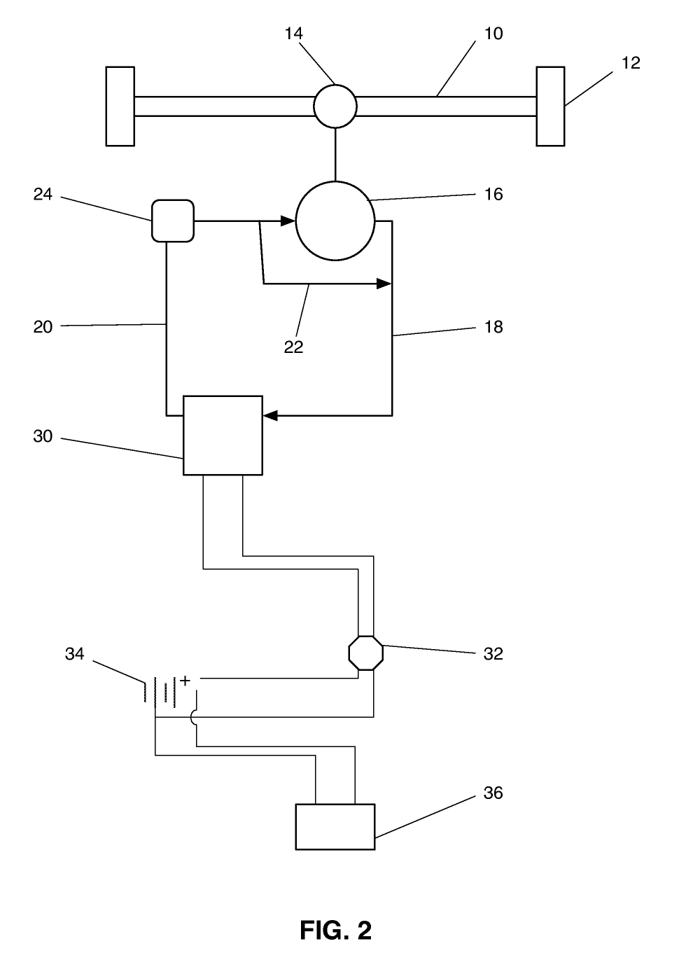

FIG. 2 depicts an alternate and preferred embodiment of the present invention. In this embodiment, the configuration of the tires 12, axle 10, differential 14, hydraulic pump 16, hydraulic circuit, and pressure bypass line 22 are essentially the same as described in connection with FIG. 1. However, a plurality of hydraulic generators 30 replaces the hydraulic motor 26 and generator 30.

In this configuration, the plurality of hydraulic generators 30 operates in parallel with each other, collectively forming a generator block 38. Again, the use of the pressure bypass line 22 provides uniform pressure and flow of hydraulic fluid to the generator block 38. Thus, the generator block 38 is capable of providing uniform electrical output over a wide range of vehicle operating parameters once the vehicle travels at or above a predetermined velocity. The generator block 38 provides electrical energy to the battery 34 or battery block for recharging the battery 34 during vehicle operation.

The hydraulic generators 30 comprising the generator block 38 are preferably matched to collectively provide electrical output within predetermined operating parameters suitable for recharging of the battery 34. Additionally, each of the plurality of hydraulic generators 30 is selected to perform within its optimum operating range. Since the hydraulic pump 16 provides uniform drive to the hydraulic generators 30 during operation, the generators 30 are capable of functioning at optimum efficiency while the vehicle travels within operating parameters.

This use of the generator block 38 overcomes limitations of prior devices using solely mechanical means and linkages between the original motive source, such as vehicle tires 12, and electrical generating means. First, direct linkages between a vehicles drive train or drop axle 10 as provided in earlier devices cause electrical generators 30 to operate over a wide range of operating parameters. As the vehicle travels faster, the generator 30 means operates faster. While regulation circuitry can be utilized between the generator 30 means and batteries, the generators 30 are forced to operate over a wide spectrum of rotation velocities. However, the generators 30 only have a limited, defined optimum operating range. The present device overcomes this limitation by providing uniform power to each generator 30. Thus, generators 30 can be selected that perform within their optimum operating range, resulting in more efficient conversion of mechanical energy into electrical energy.

Additionally, the use of several smaller generators 30 operating collectively to provide electrical output have been found to operate more efficiently than a single generator 30 providing the same electrical output. Thus, the preferred embodiment of the present invention enables efficient regeneration of kinetic energy otherwise lost from the non-drive axle 10. The present invention could also be used in other related applications wherein generators 30 are presently linked to drive shafts, drive axles 10 or tires 12, or other powered or un-powered devices within a vehicle.

Those skilled in the art of hydraulic generators 30 will appreciate that pressure bypass systems may also be integrated into the hydraulic generator 30, thus eliminating the need for a separate pressure bypass line 22 within the hydraulic circuit. Similar to the preferred embodiment in FIG. 2, a block 38 of generators 30 may be used in place of the single generator 30 described in FIG. 1. If such a configuration is used, multiple pulleys 28 may be utilized to connect the plurality of generators 30 comprising the generator block 38 to the hydraulic motor 26. Since the hydraulic system is capable of providing uniform power to the hydraulic motor 26 once the vehicle reaches or exceeds a predetermined velocity, this arrangement would provide similar functionality to the system described in connection with FIG. 2.

As has been demonstrated, the present invention provides a novel regenerative system for recharging a vehicle battery. The present invention could be used on a variety of vehicles, including electric vehicles, hybrid electric vehicles, and those powered by internal combustion engines. In other applications, the system could be utilized to provide regenerative power to locomotives or road tractors. The prior art does not teach the use of a hydraulic system coupled to a non-drive axle to provide continuous, uniform power to a generator during vehicle use. Nor does the prior art teach a means of linking an electric generator to a vehicle axle so that the generator operates within an optimum range over a wide range of vehicle speeds.

While the preferred embodiment of the present invention has been described, additional variations and modifications in that embodiment may occur to those skilled in the art once they learn of the basic inventive concepts. Therefore, it is intended that the appended claims shall be construed to include both the preferred embodiment and all such variations and modifications as fall within the spirit and scope of the invention.

I claim:

1. A hydraulic regenerative system for a vehicle comprising: at least one battery;
a hydraulic pump operably connected to a rotating axle so that the axle rotation powers the pump;
a hydraulic motor in fluid communication with the pump wherein the pump powers the hydraulic motor;
at least one generator operably connected to the hydraulic motor so that the hydraulic motor powers the at least one generator to generate electric energy, wherein the at least one generator feeds the electric energy to the at least one battery.

2. A hydraulic regenerative system for a vehicle according to claim 1, wherein the hydraulic motor provides uniform output when axle rotation exceeds a predetermined speed.

3. A hydraulic regenerative system for a vehicle according to claim 1, wherein the axle is a non-drive axle.

4. A hydraulic regenerative system for a vehicle according to claim 1, further comprising a control processor adapted to regulate recharging of the at least one battery.

5. A hydraulic regenerative system for a vehicle comprising:
at least one battery;
a hydraulic pump operably connected to a rotating axle so that the axle rotation powers the pump;
at least one hydraulic generator generating electric energy in fluid communication with the pump so that the pump powers the at least one hydraulic generator, wherein the at least one hydraulic generator feeds the electric energy to the at least one battery for recharging.

6. A hydraulic regenerative system for a vehicle according to claim 5, further comprising a control processor adapted to regulate recharging of the at least one battery.

7. A hydraulic regenerative system for a vehicle according to claim 5, wherein the axle is a non-drive axle.

8. A hydraulic regenerative system for a vehicle according to claim 1, wherein the hydraulic motor provides uniform output when axle rotation exceeds a predetermined speed.

8. A hydraulic regenerative system for a vehicle according to claim 5, further comprising a plurality of hydraulic generators in fluid communication with the pump and adapted to operate in parallel with the at least one generator, wherein the at least one generator and the plurality of generators feed the electric energy to the at least one battery for recharging.
